(19) United States
(12) Patent Application Publication
(10) Pub. No.: US 2014/0037250 A1
(43) Pub. Date: Feb. 6, 2014

(54) FIELD INSTALLED OPTICAL FIBER CONNECTOR FOR JACKETED FIBER CABLE AND TERMINATION METHOD

(71) Applicants: Daniel J. Treadwell, Austin, TX (US); Donald K. Larson, Cedar Park, TX (US); Michael A. Jessup, Dripping Springs, TX (US); William J. Clatanoff, Austin, TX (US)

(72) Inventors: Daniel J. Treadwell, Austin, TX (US); Donald K. Larson, Cedar Park, TX (US); Michael A. Jessup, Dripping Springs, TX (US); William J. Clatanoff, Austin, TX (US)

(73) Assignee: 3M INNOVATIVE PROPERTIES COMPANY, ST. PAUL, MN (US)

(21) Appl. No.: 13/992,111

(22) PCT Filed: Dec. 14, 2011
(86) PCT No.: PCT/US11/64857

§ 371 Date: Jun. 6, 2013

Related U.S. Application Data
(60) Provisional application No. 61/429,657, filed on Jan. 4, 2011.

(51) Int. Cl. G02B 6/38; G02B 6/46

(52) U.S. Cl. CPC G02B 6/381; G02B 6/46
USPC 385/78; 29/426.2

(57) ABSTRACT

An optical fiber connector includes a housing configured to mate with a receptacle, a collar body that includes a fiber stub and a mechanical splice device, a backbone to retain the collar body within the housing, and a boot. The backbone includes a cable jacket clamping portion to clamp a cable jacket that surrounds a portion of the terminated optical fiber upon actuation. The boot actuates the cable jacket clamping portion of the backbone upon attachment to the backbone. A method for terminating the optical fiber in the field includes slitting or removing a portion of the cable jacket prior to splicing the optical fiber to the fiber stub. The method also includes utilizing a protective sheath or tube to protect exposed portion of the fiber cable and provide structural integrity to the optical connector.

### BACKGROUND

1. Field of the Invention

The present invention is directed to an optical fiber connector and method for terminating a jacketed optical fiber cable in the field.

2. Related Art

Mechanical optical fiber connectors for the telecommunications industry are known. For example, LC, ST, FC, and SC optical connectors are widely used. However, commercially available optical fiber connectors are not well suited for field installations. Typically, an adhesive is required to mount these types of connectors on to an optical fiber. This process can be awkward and time consuming to perform in the field. Also post-assembly polishing requires that the craftsman have a higher degree skill.

Also known are hybrid optical fiber splice connectors, as described in JP Patent No. 3445479, JP Application No. 2004-210251 (WO 2006/019516) and JP Application No. 2004-210357 (WO 2006/019515). However, these hybrid splice connectors are not compatible with standard connector formats and require significant piecewise assembly of the connector in the field. The handling and orientation of multiple small pieces of the connector can result in incorrect connector assembly that may either result in decreased performance or increase the chance of damaging the fiber.

More recently, U.S. Pat. No. 7,369,738 describes an optical fiber connector that includes a pre-polished fiber stub disposed in ferrule that is spliced to a field fiber with a mechanical splice. Such a connector, called an NPC, is now commercially available through 3M Company (St. Paul, Minn.).

### SUMMARY

According to a first aspect of the present invention, an optical fiber connector for terminating a jacketed optical fiber cable is provided. The optical fiber connector includes a housing configured to mate with a receptacle. The optical fiber connector also includes a collar body disposed in the housing, wherein the collar body includes a fiber stub disposed in a first end portion of the collar body. The fiber stub is mounted in a ferrule and has a first end proximate to an end face of the ferrule and a second end. The collar body further includes a mechanical splice device disposed in a portion of the collar body, where the mechanical splice device is configured to splice the second end of the fiber stub to an optical fiber from the jacketed optical fiber cable. The optical fiber connector also includes a backbone to retain the collar body within the housing, the backbone including a cable jacket clamping portion to clamp a cable jacket that surrounds a portion of the optical fiber upon actuation. The optical fiber connector also includes a boot attachable to a portion of the backbone, wherein the boot actuates the cable jacket clamping portion of the backbone upon attachment to the backbone. The optical fiber connector also includes a tube or sheath configured to protect an exposed portion of the optical fiber. The tube or sheath can be positioned such that a portion of the tube or sheath is disposed underneath the attached boot.

According to another aspect of the present invention, a method for terminating a jacketed optical fiber cable in an optical connector having a fiber stub and a cable jacket clamp is provided. The jacketed optical fiber cable includes an optical fiber, a buffer coating surrounding the optical fiber, a cable jacket surrounding the buffer coating, and strength members axially disposed between the cable jacket and buffer coating. The method comprises removing a portion of the fiber cable jacket at the terminal end of the jacketed optical fiber cable. The method further comprises slitting a portion of the fiber cable jacket along its axial length to form a slit portion of the cable jacket that is axially disposed between an intact portion of the cable jacket nearest the terminal end of the fiber cable, the intact portion called a jacket band, and the remainder of the cable jacket. The jacket band is pulled back along the axial length of the optical fiber cable away from the terminal end of the fiber and towards the remainder of the cable jacket such that the slit portion expands outward from the optical fiber cable exposing the buffer coating and strength members. The terminal end of the optical fiber is prepared and is coupled to the stub fiber to form a splice between the terminal end of the fiber and the stub fiber. The method further includes sliding the jacket band toward the splice such that the slit portion is substantially returned to its pre-expanded shape, wherein at least a portion of the jacket band is disposed within the cable jacket clamp. A protective tube is placed over the jacket band and slit portion. A boot is secured over the cable jacket clamp to clamp the cable jacket clamp onto the protective tube and to secure strength members to the optical connector.

In an alternative method, a portion of the cable jacket is removed between the jacket band and the remainder of the cable jacket. The jacket band is pulled back along the axial length of the optical fiber cable away from the terminal end of the fiber and towards the remainder of the cable jacket. The terminal end of the optical fiber is prepared and is coupled to the stub fiber to form a splice between the terminal end of the fiber and the stub fiber. The jacket band is slid toward the splice, wherein at least a portion of the jacket band is disposed within the cable jacket clamp. A protective tube is placed over the jacket band and exposed fiber. A boot is secured over the cable jacket clamp to clamp the cable jacket clamp onto the protective tube and to secure strength members to the optical connector.

The above summary of the present invention is not intended to describe each illustrated embodiment or every implementation of the present invention. The figures and the detailed description that follows more particularly exemplify these embodiments.

### BRIEF DESCRIPTION OF THE DRAWINGS

The present invention will be further described with reference to the accompanying drawings, wherein:

FIG. 1 is an isometric view of an optical fiber connector according to an embodiment of the present invention.

FIG. 2A is an exploded view of an optical fiber connector according to an embodiment of the present invention.

FIG. 2B is a schematic cross-sectional view of an optical fiber connector according to an embodiment of the present invention.

FIG. 2C is an isometric view of an exemplary collar body of an optical fiber connector according to an embodiment of the present invention.

FIG. 2D is an isometric view of an exemplary backbone of an optical fiber connector according to an embodiment of the present invention.

FIG. 2E is a side view of an exemplary boot of an optical fiber connector according to an embodiment of the present invention.

FIG. 3A shows a side view of an in-process optical fiber cable and FIGS. 3B-3C show isometric views of the optical fiber connector during different stages of an exemplary field termination process according to an embodiment of the present invention.

FIG. 4A shows a side view of an alternative in-process optical fiber cable and FIGS. 4B-4C show isometric views of the optical fiber connector during different stages of an alternative exemplary field termination process according to an embodiment of the present invention.

FIGS. 5A and 5B show isometric views of the optical fiber connector during the final stages of the exemplary field termination processes according to embodiments of the present invention.

FIG. 6 shows an exemplary fiber termination tool.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the scope of the invention as defined by the appended claims.

### DETAILED DESCRIPTION OF THE EMBODIMENTS

In the following Detailed Description, reference is made to the accompanying drawings, which form a part hereof, and in which is shown by way of illustration specific embodiments in which the invention may be practiced. In this regard, directional terminology, such as “top,” “bottom,” “front,” “back,” “leading,” “forward,” “trailing,” etc., is used with reference to the orientation of the Figure(s) being described. Because components of embodiments of the present invention can be positioned in a number of different orientations, the directional terminology is used for purposes of illustration and is in no way limiting. It is to be understood that other embodiments may be utilized and structural or logical changes may be made without departing from the scope of the present invention.

The present invention is directed to an optical fiber connector and method of field termination of a jacketed optical fiber cable. In particular, the optical fiber connector of the exemplary embodiments is of compact length and is capable of straightforward field termination. The exemplary connector(s) described herein can be readily installed and utilized for Fiber To The Home (FTTH) and/or Fiber To The X (FTTX) network installations. The exemplary connector(s) can be utilized in installation environments that require ease of use when handling multiple connections, especially where labor costs are more expensive.

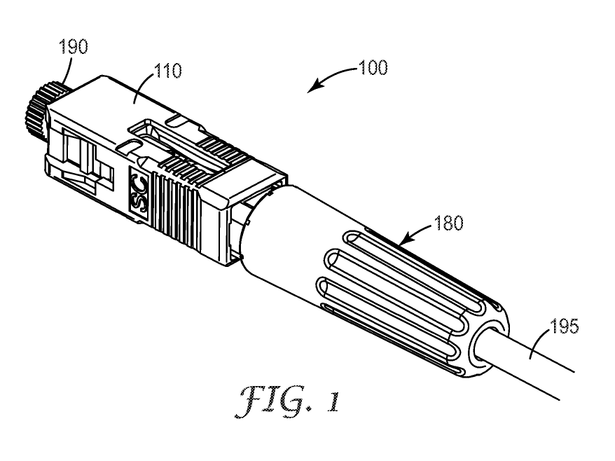

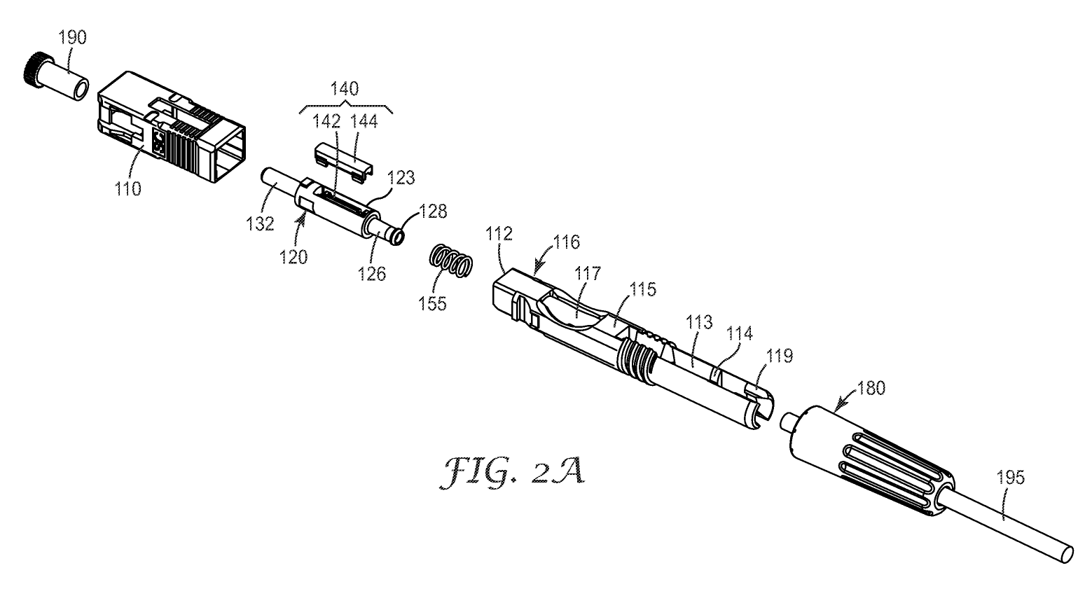

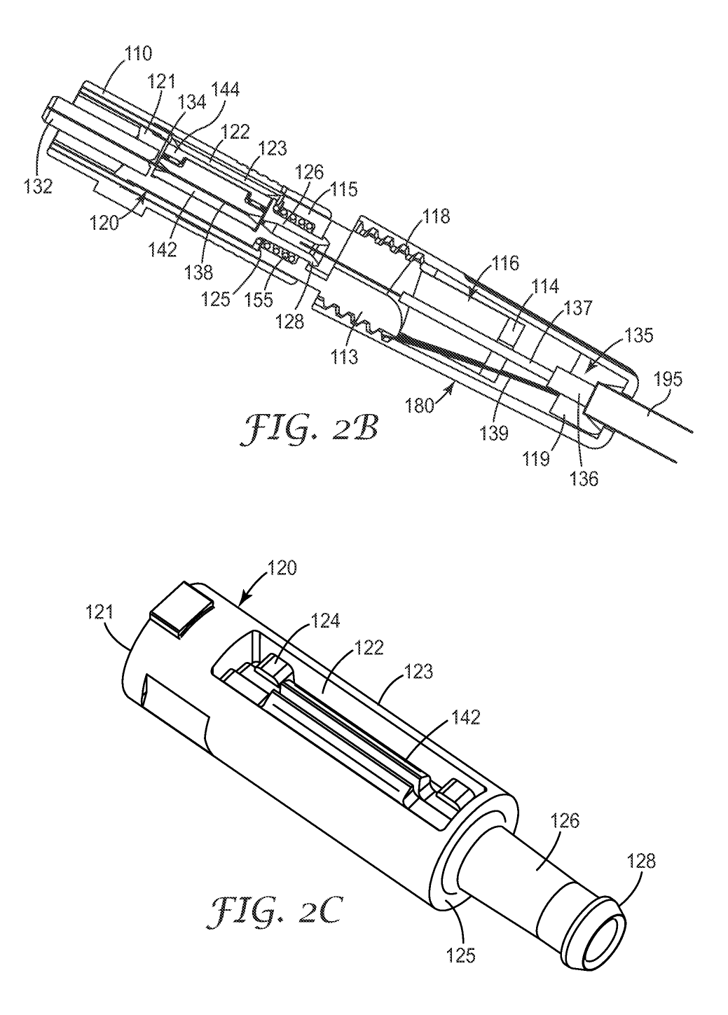

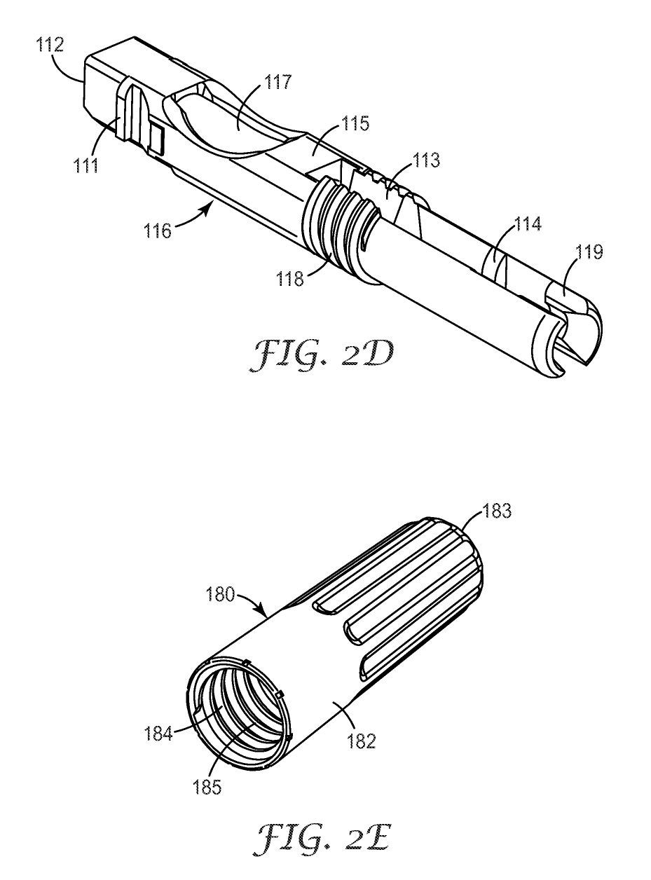

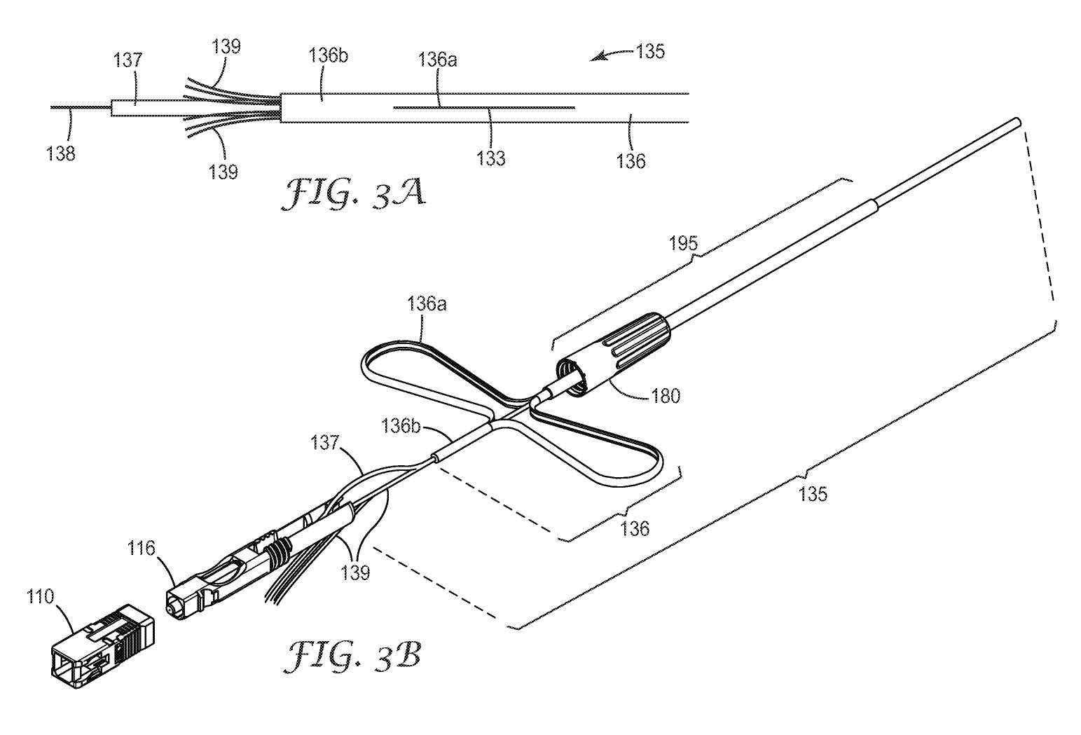

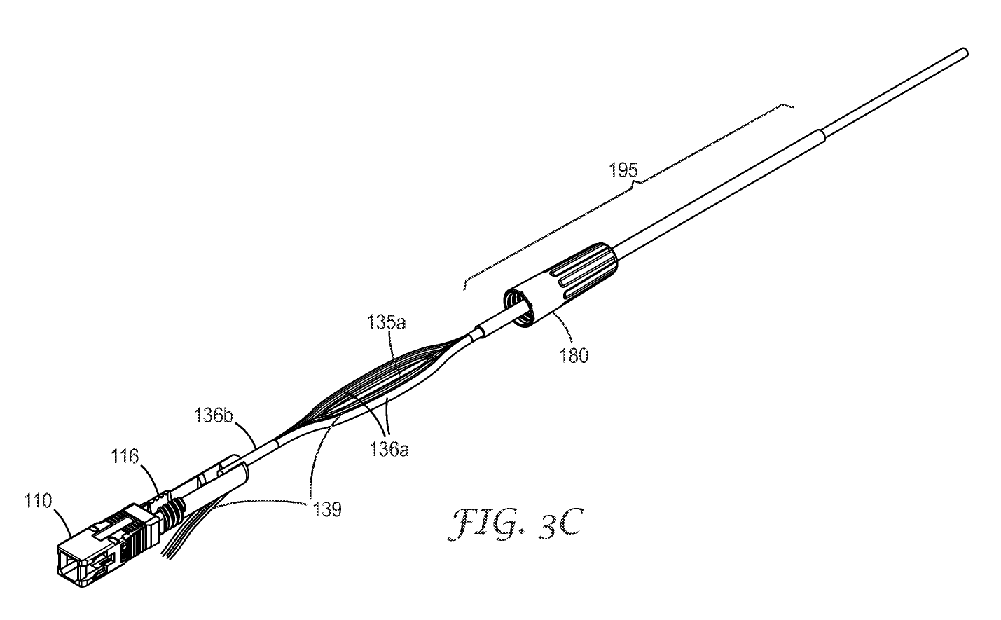

According to an exemplary embodiment of the present invention, an optical fiber connector 100 is shown in isometric view in FIG. 1. The components of the optical fiber connector are shown in an exploded view in FIG. 2A. FIG. 2B shows a section view of the optical fiber connector 100. FIGS. 2C-2E show close up views of elements of the optical fiber connector, including the collar body 120, the backbone 116, and the boot 180. FIGS. 3A-3C, 4A-4C, and 5A-5B show in-process views of the connector during alternative termination processes.

Optical connector 100 is configured to mate with a receptacle of a corresponding format. For example, as shown in FIG. 1, exemplary optical connector 100 is configured as having an SC format. However, as would be apparent to one of ordinary skill in the art given the present description, optical connectors having other standard formats, such as ST, FC, and LC connector formats, can also be provided.

As shown in FIG. 1, SC-type optical fiber connector 100 can include a connector body having a housing 110 and a fiber boot 180. A cap 190 can be placed at the front end of the connector to protect the stub fiber end when not in use.

Connector 100 includes a housing 110 having an outer shell configured to be received in an SC receptacle (e.g., an SC coupling, an SC adapter, or an SC socket). As shown in FIG. 2A, connector 100 also includes a collar body 120 (which can also be referred to as a barrel) to house a ferrule and a splice device, a multi-purpose backbone 116 that retains the collar body 120 within the connector, a boot 180, and a protective tube or sheath 195 that covers an exposed portion of the optical fiber cable (as is explained in more detail below).

In this exemplary embodiment, connector 100 can be utilized to terminate a field optical fiber cable 135 (see e.g., FIG. 2B). Optical fiber cable 135 is a jacketed optical fiber cable that includes a cable jacket 136, a coated portion 137 (e.g., with a buffer coating or the like), a fiber portion 138 (e.g., the bare clad/core), and strength members 139. In a preferred aspect, the strength members 139 comprise aramid, Kevlar, or polyester yarn or strands disposed between an inner surface of the cable jacket 136 and an outer surface of coated (buffered) portion 137. Optical fiber cable 135 can be a standard cylindrically shaped cable structure or it can be an alternatively shaped structure, such as a rectangular-shaped cable. In an exemplary aspect, the optical fiber cable 135 is a standard optical fiber cable having a 900 μm outer diameter coated portion 137 and a cable jacket 136 having an outer diameter of from about 1.6 mm to about 3.0 mm. Of course, in alternative aspects, the connector can be adapted to accommodate fiber cables of different dimensions, as would be apparent to one of skill in the art given the present description.

In one aspect, the backbone 116 (see e.g., FIGS. 2A and 2D) provides structural support for the connector 100. In a further aspect, the backbone 116 is an elongated structure (having a length of from about 50 mm to about 60 mm) that also provides clamping for the optical fiber being terminated in the field. Moreover, the backbone 116 can provide further axial strain relief by providing a clamping surface for the strength members of the optical fiber being terminated.

Backbone 116 includes an opening 112 at a front end to allow for insertion of the collar body 120. Backbone 116 further includes an access opening 117, which can provide access to actuate a mechanical splice device disposed within the connector collar body. In a preferred aspect, as is shown in FIG. 2D, access opening 117 can have a cut-out or shallow depression formed on the sides to accommodate a user's thumb or finger during actuation of the splice device. The backbone 116 has an axial bore throughout to permit passage of the optical fiber being terminated. As is also shown in more detail in FIG. 2D, backbone 116 can further include a mounting structure 118 that provides for coupling to the fiber boot 180. In an exemplary aspect, the mounting structure comprises a threaded surface formed on an outer portion of backbone 116 that is configured to engage corresponding threaded grooves 184 of the boot 180 (see FIG. 2E). Also, the mounting structure 118 can provide a retention area for securing the strength members of the optical fiber cable being terminated.

In addition, the backbone can include a fiber guide 113 formed in an interior portion therein to provide axial alignment support for the optical fiber cable being terminated. In an exemplary aspect, the fiber guide portion 113 is a funnel-shaped channel or groove that aligns a buffered portion of the optical fiber and guides the fiber toward the mechanical splice device 140 housed in the collar body 120.

The backbone 116 also includes a collar body mount structure 115 configured to receive and secure the collar body 120 within the backbone. In a preferred aspect, collar body mount structure 115 comprises a rigid structure formed in an interior region of backbone 116 having an axial bore therethrough. The axial bore can be of appropriate size to receive and engage raised end structure 128 of collar body 120 (see FIG. 2B). In addition, collar body mount structure 115 also forms a shoulder that can be used as a flange to provide resistance against spring 155 that is positioned over the second end portion 126 of the collar body 120. The spring 155 provides and maintains an adequate contact force when two connectors are joined together.

Backbone 116 can further include one or more stops 114 formed on an interior portion thereof to provide a boundary for the insertion of the cable jacket 136 of the optical fiber cable 135 being terminated (as explained in more detail below). In addition, backbone 116 includes a clamping portion 119 formed at one an end of the backbone. The clamping portion 119 is configured to clamp onto the cable jacket 136 of the optical fiber cable 135 being terminated in connector 100. In a preferred aspect, clamping portion 119 comprises a collet-type, split body shape that is actuated when the boot is secured to mounting structure 118. The clamping portion 119 can include raised inner surfaces to permit ready clamping of the cable jacket 136. In addition, the clamping portion 119 also can provide a guide structure when inserting fiber cable 135 during the termination process. Thus, boot 180 can be utilized to clamp the fiber strength members 139 and the cable jacket 136. The interaction of the boot 180 and the backbone 116 will be described in greater detail below.

The connector also includes a tube or sheath 195 to be placed over the cable jacket of the optical fiber cable. The tube or sheath can be constructed from a conventional material, such as a plastic (e.g., plasticized PVC, urethanes, silicones, elastomers). As explained in more detail below, during the exemplary termination process, the cable jacket 136 can be slit or removed to leave an exposed portion of the fiber cable. The tube or sheath 195 is adapted to slide over the cable jacket at the slit or removed portion to protect and/or conceal the exposed portion of the fiber. In addition, the tube or sheath 195 can provide additional structural integrity against extraneous forces, such as side-pulls. The tube or sheath 195 is configured to have an axial length sufficient to cover the slit portion of the cable jacket or the exposed portion of the optical fiber. In a preferred aspect, the tube or sheath 195 extends well beyond the end of the attached boot 180 when connected with the backbone 116. In addition, tube or sheath 195 can act as an adapter tube when the optical fiber cable being clamped is of an even smaller diameter.

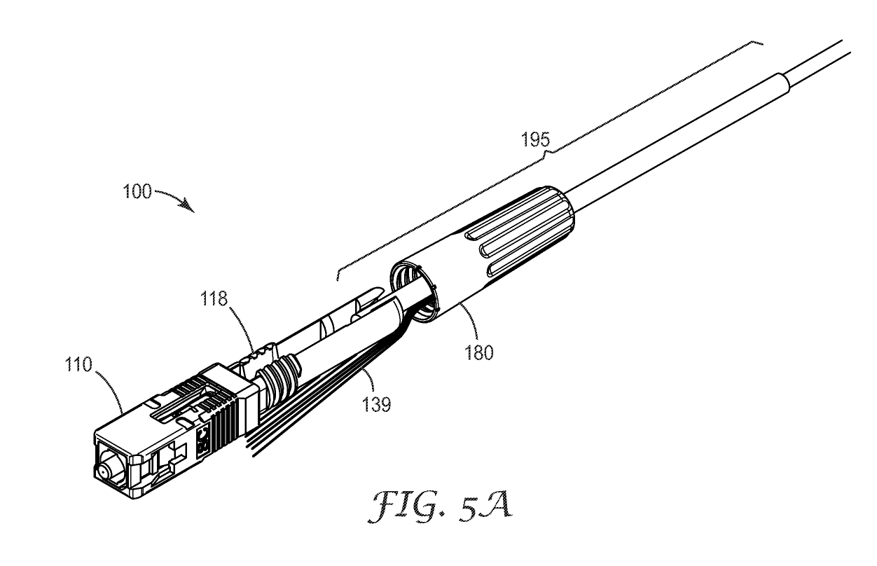

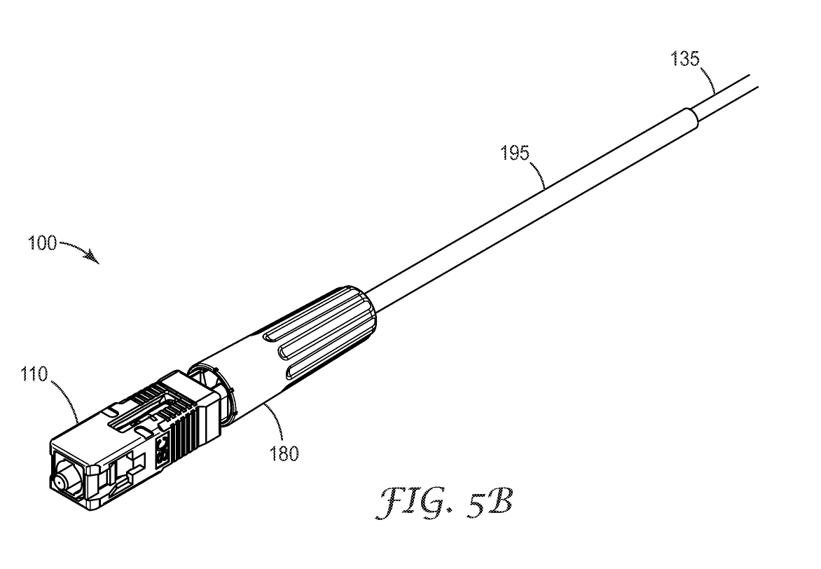

According to an exemplary embodiment of the present invention, housing 110 and backbone 116 are formed or molded from a polymer material, although metal and other suitably rigid materials can also be utilized. For example, one exemplary material can comprise a fiberglass reinforced polyphenylene sulfide resin. Housing 110 is preferably secured to an outer surface of backbone 116 via snap fit (see e.g., outer engagement surface 111 shown in FIG. 5).

As mentioned above, connector 100 further includes a collar body 120 that is disposed within the connector housing and retained by the backbone. According to exemplary embodiments, the collar body 120 is a multi-purpose element that can house a ferrule 132 and optical fiber stub 134 and a mechanical splice device 140. The collar body is configured to have some limited axial movement within backbone 116. For example, the collar body 120 can include a collar or shoulder 125 that can be used as a flange to provide resistance against spring 155 (see FIGS. 2A and 2B), interposed between the collar body and the collar body mount structure 115. According to an exemplary embodiment of the present invention, collar body 120 can be formed or molded from a polymer material, although metal and other suitable materials can also be utilized. For example, collar body 120 can comprise an injection-molded, polymer material.

In particular, collar body 120 includes a first end portion 121 having an opening to receive and house a ferrule 132 having an optical fiber stub 134 secured therein. The collar body also includes a second end portion 126 configured to engage with the collar body mount structure 115 of backbone 116. In a preferred aspect, second end portion 126 has a raised end structure 128 that has a sloping shape that is insertable through the bore of the collar body mount structure 115, as is shown in FIG. 2B. Raised end structure 128 of the second end portion can be inserted into the bore and engage against collar body mount structure 115 due to the bias of the spring 155.

The collar body 120 also secures the fiber stub and ferrule in place in the connector 100. Ferrule 132 can be formed from a ceramic, glass, plastic, or metal material to support the optical fiber stub 134 inserted and secured therein. In a preferred aspect, ferrule 132 is a ceramic ferrule.

An optical fiber stub 134 is inserted through the ferrule 132, such that a first fiber stub end slightly protrudes from or is coincident or coplanar with the end face of ferrule 132. Preferably, this first fiber stub end is factory polished (e.g., a flat or angle-polish, with or without bevels). A second end of the fiber stub 134 extends part-way into the interior of the connector 100 and is spliced to the fiber portion 138 of an optical fiber cable (such as optical fiber cable 135). Preferably, the second end of fiber stub 134 can be cleaved (flat or angled, with or without bevels).

In one aspect, the second end of fiber stub 134 can be polished in the factory to reduce the sharpness of the edge of the fiber, which can create scrapings (debris) as it is installed in the splice element. For example, an electrical arc, such as one provided by a conventional fusion splicer machine, can be utilized to melt the tip of the fiber and form a rounded end, thereby removing the sharp edges. This electrical arc technique can be used in conjunction with polishing by an abrasive material to better control end face shape while reducing possible distortion of the core. An alternative non-contact method utilizes laser energy to ablate/melt the tip of the fiber.

Fiber stub 134 and fiber portion 138 can comprise standard single mode or multimode optical fiber, such as SMF 28 (available from Corning Inc.). In an alternative embodiment, fiber stub 134 additionally includes a carbon coating disposed on the outer clad of the fiber to further protect the glass-based fiber. In an exemplary aspect, fiber stub 134 is pre-installed and secured (e.g., by epoxy or other adhesive) in ferrule 132, which is disposed in the first end portion 121 of collar body 120. Ferrule 132 is preferably secured within collar body first end portion 121 via an epoxy or other suitable adhesive. Preferably, pre-installation of the fiber stub can be performed in the factory.

Referring back to FIG. 2C, collar body 120 further includes a splice element housing portion 123. In an exemplary aspect, splice element housing portion 123 provides an opening 122 in which a mechanical splice element 142 can be inserted and secured in the central cavity of collar body 120. In an exemplary embodiment, mechanical splice element 142 is part of a mechanical splice device (also referred to herein as a splice device or splice), such as a 3M™ FIBRLOK™ mechanical fiber optic splice device, available from 3M Company, of Saint Paul, Minn.

For example, commonly owned U.S. Pat. No. 5,159,653, incorporated herein by reference in its entirety, describes an optical fiber splice device (similar to a 3M™ FIBRLOK™ II mechanical fiber optic splice device) that includes a splice element that comprises a sheet of ductile material having a focus hinge that couples two legs, where each of the legs includes a fiber gripping channel (e.g., a V-type (or similar) groove) to optimize clamping forces for conventional glass optical fibers received therein. The ductile material, for example, can be aluminum or anodized aluminum. In addition, a conventional index matching fluid can be preloaded into the V-groove region of the splice element for improved optical connectivity within the splice element. In another aspect, no index matching fluid is utilized.

In this exemplary aspect, the splice element 142 can be configured similar to the splice element from a 3M™ FIBRLOK™ II mechanical fiber optic splice device or a 3M™ FIBRLOK™ 4×4 mechanical fiber optic splice device. Other conventional mechanical splice devices can also be utilized in accordance with alternative aspects of the present invention and are described in U.S. Pat. Nos. 4,824,197; 5,102,212; 5,138,681; 5,155,787; and 7,140,787, each of which is incorporated by reference herein, in their entirety.

Mechanical splice element 142 allows a field technician to splice the second end of fiber stub 134 to a stripped fiber portion 138 of an optical fiber cable 135 at a field installation location. In an exemplary embodiment, utilizing a 3M™ FIBRLOK™ II mechanical fiber optic splice device, splice device 140 can include splice element 142 and an actuating cap 144 (FIG. 2A). The two fiber ends, (e.g., one end of fiber stub 134 and one end of fiber portion 138 from optical fiber cable 135) are butted against each other and held in place in the splice element, such as in a V-groove channel, to provide sufficient optical connection. In operation, as the cap 144 is moved from an open position to a closed position (e.g. downward in the embodiment depicted in FIG. 2A), one or more cam bars located on an interior portion of the cap 144 can slide over the splice element legs, urging them toward one another to complete the splice.

Splice element 142 is mountable in a mounting device or cradle 124 (partially shown in FIG. 2C) that is located in splice element housing portion 123 of collar body 120. In an exemplary embodiment, cradle 124 is integrally formed in collar body 120, e.g., by molding. Cradle 124 can secure (through e.g., snug or snap-fit) the axial and lateral position of the splice element 142. The mounting device 124 can be configured to hold the splice element such that the splice device cannot be rotated or easily moved forward or backward once installed.

The mechanical splice allows a field technician to splice the second end of fiber stub 134 to the fiber portion 138 of an optical fiber cable 135 at a field installation location. The term “splice,” as utilized herein, should not be construed in a limiting sense since splice device 140 can allow removal of a fiber. For example, the element can be “re-opened” after initial actuation, where the splice element housing portion can be configured to allow for the removal of the actuating cap if so desired by a screw driver or similar device. This configuration permits repositioning of the spliced fibers, followed by replacement of the cap to the closed position.

As mentioned above, fiber boot 180 can be utilized for several purposes with optical connector 100. As shown in FIG. 2E, boot 180 includes a tapered body 182 having an axial bore throughout. The boot 180 includes threaded grooves 184 formed on an inner surface of the body 182 at the opening 185, where the grooves are configured to engage with the correspondingly threaded mounting structure 118 of the backbone 116. In addition, the axial length of boot 180 is configured such that a rear section 183 of the boot, which has a smaller opening than at front opening 185, engages the jacket clamp portion 119 of the backbone. For example, as is explained in more detail below, as the boot 180 is secured onto the mounting structure 118 of the backbone, the axial movement of the boot relative to the backbone forces the legs of clamp portion 119 to move radially inwards so that the cable jacket 136/tube 195 is tightly gripped. Also, the strength members 139 of the optical fiber cable can be disposed between the boot and the threaded mounting structure 118 to secure the strength members as the boot is installed. This construction can also provide a connector termination capable of surviving rougher handling and greater pull forces.

In an exemplary aspect, boot 180 is formed from a rigid material. For example, one exemplary material can comprise a fiberglass reinforced polyphenylene sulfide resin or a polyether imide resin, such as an ULTEM material (available from SABIC). In another aspect, the materials used to form the boot 180 and the backbone 116 are the same.

An exemplary fiber cable utilized in this embodiment comprises a 3.0 mm jacketed communication cable, such as a patch cord or drop cable, commercially available from Samsung Cable, Thai-han Cable, and others (all of Korea). As would be understood by one of ordinary skill in the art given the present description, the optical connector of the exemplary embodiments can be configured to terminate the fibers of other types of jacketed cable, including 3.5 mm communication cable, and others.

As mentioned above, the optical fiber connector of the exemplary embodiments is of compact length and is capable of straightforward field termination. An exemplary termination process according to exemplary aspects of the present invention is now described with reference to FIGS. 3A-3C, FIGS. 4A-4C, and FIGS. 5A-5B. Please note that reference numbers used in these figures correspond with like features from FIGS. 1 and 2A-2E.

As discussed above, the optical fiber connector is partly assembled by inserting the collar body 120, with ferrule 132 secured therein, into the opening 112 of the backbone 116. This step may be performed prior to the field termination process or during the field termination process. As mentioned above, the raised end structure 128 of the collar body is inserted into the bore of collar body mount structure 115. The spring 155 is placed over the second portion of the collar body prior to installation in the backbone and will provide some bias against axial movement after insertion.

For field termination, an optical fiber cable, such as cable 135, is prepared by stripping off a small portion of the cable jacket 136 at the cable end, leaving the remaining coated portion 137, fiber portion 138, and strength members 139 intact. For the exemplary SC-type connector 100 shown in the figures, this small portion of the cable jacket can be about 65 mm or so. In one aspect, a portion of the cable jacket 136 can be slit along its axial length to leave a slit portion of the cable jacket and an intact portion of the cable jacket nearest the terminal end of the fiber cable.

This cable preparation is illustrated in FIGS. 3A and 3B. FIG. 3A shows an exemplary optical fiber cable 135 having a cable jacket 136, a slit 133 extending axially along a substantial portion of the cable jacket (the region of the cable jacket with the slit is referred to herein as the slit portion 136a and the slit operation is described further below), the coated portion 137, fiber portion 138, and strength members 139. FIGS. 3A and 3B also show the slit portion 136a of the cable jacket and the intact portion 136b (also referred to as the jacket band) nearest the end of the fiber. The slit portion 136a is disposed between the jacket band 136b and the remainder of the cable jacket. The slit portion 136a of the cable jacket is slit (e.g., by making multiple axial/longitudinal cuts of substantial length) such that it expands outward or flowers as the jacket band is pulled back (away from the terminal end of the fiber) along the axial length of the fiber cable (as is illustrated in FIG. 3B). A conventional cable slitting tool, such as is commercially available from Senko, can be utilized to slit the cable jacket 136. In one preferred aspect, the slit 133 can have a longitudinal/axial length of about 5-15 cm.

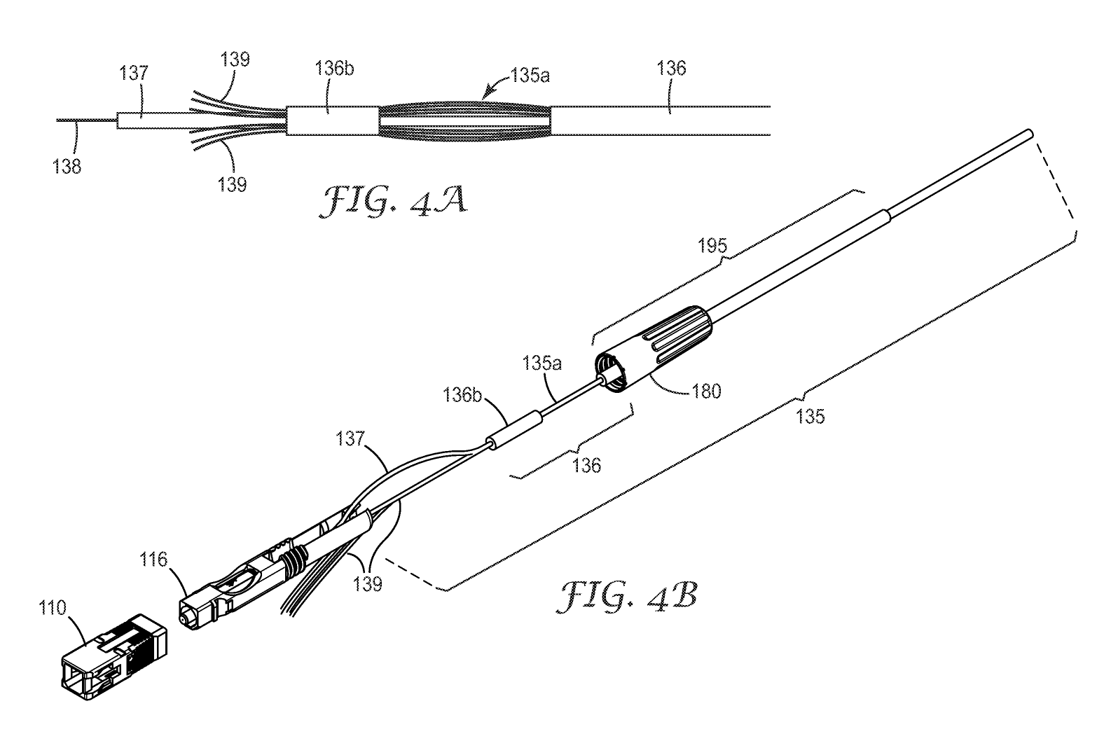

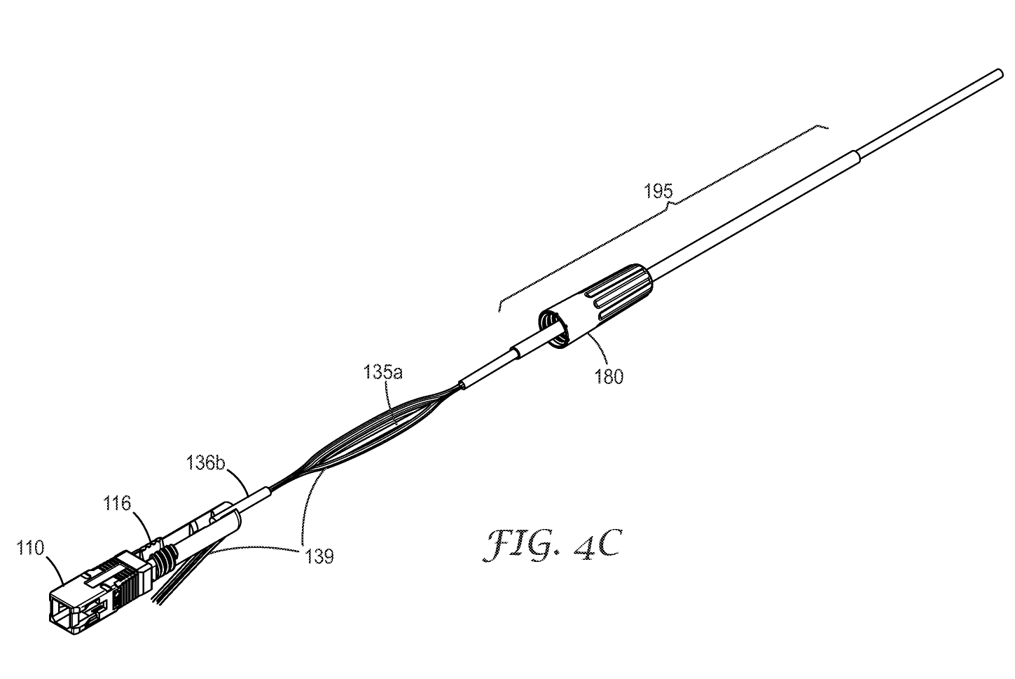

In an alternative aspect, such as is shown in FIGS. 4A and 4B, instead of slitting the cable jacket, a portion of the cable jacket can be completely removed between the jacket band 136b and the remainder of the cable jacket, leaving an exposed portion 135a of the optical fiber cable. A simple razor or other cutting tool can be utilized to remove a portion of the cable jacket. The removed cable jacket can have a longitudinal/axial length of about 5-15 cm.

After the slitting of or removal of a portion of the cable jacket, the jacket band is pulled back along the axial length of the fiber cable as is shown in FIGS. 3B and 4B. In a preferred aspect, the jacket band 136b is pulled back a substantial distance (e.g., about 5-15 cm from the end of the fiber) or until the edge of the jacket band 136b contacts the remainder of the cable jacket 136. Thus, the coated portion 137 and strength members 139 are exposed near the terminal end of the optical fiber cable. The terminal end of the fiber is further prepared by stripping off a portion of the coated portion 137 near the terminating fiber end to leave a bare fiber portion 138. The fiber end can be cleaned to remove any remaining residue. The fiber end can be cleaved (flat or angled) to match the orientation of the pre-installed fiber stub. In an exemplary aspect, about 25 mm-35 mm of stripped fiber remains. For example, a commercial fiber cleaver such as an Ilsintech MAX CI-01 or the Ilsintech MAX CI-08, available from Ilsintech, Korea (not shown) can be utilized to provide a flat or an angled cleave. No polishing of the fiber end is required, as a cleaved fiber can be optically coupled to the fiber stub 134 in the splice device. The boot 180 can be slid over the fiber cable 135 and tube or sheath 195 for later use.

In addition, in an alternative aspect of the invention, the terminal end of the fiber can be placed in a termination tool or platform for the stripping, cleaving, and cleaning operations.

As shown in FIGS. 3B and 4B, the terminal end of optical fiber cable 135 can be inserted in the rear end of the connector (i.e., through the clamping portion 119 of the connector backbone). In this manner, the prepared fiber end can be spliced to the fiber stub with the mechanical splice device 140. The fiber cable 135 is continually inserted until the coated portion 137 of the fiber begins bowing (which occurs as the end of fiber portion 138 meets the fiber stub 134 with sufficient end loading force). In addition, the stops 114 formed on an interior portion of the backbone can provide a boundary to stop further insertion of the cable jacket 136 of the optical fiber cable 135.

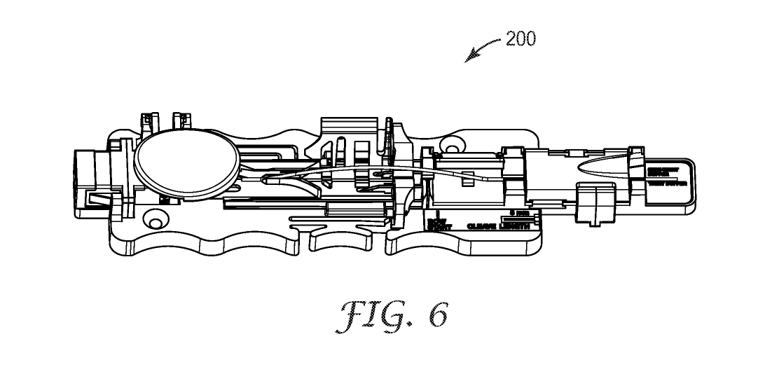

The splice device can then be actuated while the fibers are subject to an appropriate end loading force. To actuate the splice device, a user presses downward (with a modest thumb or finger force) onto the cap 144 of the splicing device. Alternatively, connector 100 can be mounted in a termination platform or tool, such as the 8865 AT tool, commercially available from 3M Company. In this manner, a portion of the fiber cable can be clamped by the termination tool during the actuation process. For example, FIG. 6 shows an exemplary termination tool 200 usable with the termination processes described herein.

The cable jacket can then be released at clamping portion 119 or by the clamp on the termination tool, thereby releasing the fiber bow.

As the investigators have determined, when the contact force between the stub fiber and field fiber is too high, fiber mis-alignment can occur, which may lead to optical losses. This contact force can increase when the fiber coating is very stiff or the length of the field fiber is very short. This high force can be alleviated by temporarily removing the cable jacket from the terminal end of the fiber prior to termination to the stub fiber. The above mentioned slitting and cable jacket displacement process exposes a (relatively) long length of the buffer coated fiber at the terminated end. As is shown in FIG. 3C, once the fiber is terminated into the end of the connector, the jacket band 136b can be slid forward toward the terminated end of the fiber such that the expanded/flowered portion of the slit cable jacket 136a is substantially returned to its pre-expanded shape, but leaving an exposed portion 135a of the fiber cable, where at least a portion of the jacket band is disposed within the jacket clamp portion 119 of the backbone 116. For the alternative aspect, as is shown in FIG. 4C, the cable jacket band 136b can be slid forward such that at least a portion of the jacket band is disposed within the jacket clamp portion 119 of the backbone 116, leaving an exposed portion 135a of the fiber cable.

After the jacket band has been disposed at the rear end of the connector, the tube or sheath 195 is moved toward the rear end of the connector to cover the exposed portion 135a of the fiber cable and at least a portion of the jacket band 136b. In addition, at least a portion of the tube or sheath 195 is disposed in the jacket clamp portion 119 of the backbone 116.

The boot 180 (which is previously placed over fiber cable 135) is then pushed axially toward the backbone mounting structure 118 (see FIG. 5A) and then screwed onto the backbone mounting structure 118 to secure the boot 180 in place. As mentioned above, the installation of the boot 180 onto the backbone 116 tightens the collet-style clamping portion 119 onto the cable jacket/protective tube. During this installation, the user can hold the strength members 139 in place over the mounting structure 118 by application of a modest force (e.g., by thumb pressure). As the boot 180 is mounted onto the backbone mounting structure 118, the strength members are secured in place between the boot 180 and the backbone mounting structure 118. After completion of the boot installation, the excess strength members can be removed (e.g., cut away). The resulting terminated optical connector 100 is shown in FIG. 5B.

While the above termination processes are described with respect to the exemplary 3.0 mm jacketed optical fiber cable, the termination processes described herein can be utilized with jacketed optical fiber cables of other sizes and shapes. Furthermore, the termination processes described herein can be utilized with optical connectors that connect single or multiple optical fibers. Also, the termination processes described herein can be utilized to form a restoration splice or with optical connectors that do not incorporate a fiber stub. In addition, the termination processes described herein can be utilized with or without a termination tool or platform to hold the optical connector during the termination process.

Thus, the above termination procedure can be accomplished in the field and allow for optimal axial pre-loading of the fiber into the splice device with reduced bow forces as the cable jacket can be displaced from the terminal end of the field fiber. In addition, the use of an axially displaceable cable jacket band allows the installer to organize the fiber and strength members during the final stages of assembly by sliding the cable jacket band towards the end of the field fiber and provides a more robust assembly. The optical connector is re-usable in that the actuating cap can be removed and the above steps can be repeated.

The optical connectors described above can be used in many conventional optical connector applications such as drop cables and/or jumpers. The optical connectors described above can also be utilized for termination (connectorization) of optical fibers for interconnection and cross connection in optical fiber networks inside a fiber distribution unit at an equipment room or a wall mount patch panel, inside pedestals, cross connect cabinets or closures or inside outlets in premises for optical fiber structured cabling applications. The optical connectors described above can also be used in termination of optical fiber in optical equipment. In addition, one or more of the optical connectors described above can be utilized in alternative applications.

As mentioned above, the optical connector of the exemplary embodiments is of compact length and is capable of straightforward field termination. Such exemplary connectors can be readily installed and utilized for FTTP and/or FTTX network installations.

Various modifications, equivalent processes, as well as numerous structures to which the present invention may be applicable will be readily apparent to those of skill in the art to which the present invention is directed upon review of the present specification.

We claim:

1. An optical fiber connector for terminating a jacketed optical fiber cable, comprising:
a housing configured to mate with a receptacle;
a collar body disposed in the housing, wherein the collar body includes a fiber stub disposed in a first end portion of the collar body, the fiber stub being mounted in a ferrule and having a first end proximate to an end face of the ferrule and a second end, wherein the collar body further includes a mechanical splice device disposed in a portion of the collar body, the mechanical splice device configured to splice the second end of the fiber stub to an optical fiber from the jacketed optical fiber cable;
a backbone to retain the collar body within the housing, the backbone including a cable jacket clamping portion to clamp a cable jacket that surrounds a portion of the optical fiber upon actuation;
a boot attachable to a portion of the backbone, wherein the boot actuates the cable jacket clamping portion of the backbone upon attachment to the backbone; and
a tube or sheath configured to protect an exposed portion of the optical fiber, wherein an end portion of the tube or sheath is disposed underneath the attached boot.

2. The optical fiber connector of claim 1, wherein the boot retains a strength member of the optical fiber against a mounting portion of the backbone.

3. The optical fiber connector of claim 1, wherein the optical connector is configured to mate with an SC receptacle.

4. The optical fiber connector of claim 1, wherein the mechanical splice device comprises a splice element and an actuating cap.

5. The optical fiber connector of claim 1, wherein the cable jacket clamping portion comprises a collet-type, split body shape.

6. The optical fiber connector of claim 1, wherein the boot attaches to the backbone view a screw-type mechanism.

7. The optical fiber connector of claim 1, wherein the backbone further includes an access area having an opening and a shallow depression formed on the sides thereof to accommodate finger actuation of the mechanical splice device.

8. The optical fiber connector of claim 1, wherein the backbone includes stops formed on an inner surface thereof to prevent passage of a jacketed fiber from further insertion.

9. The optical fiber connector of claim 1, wherein the jacketed optical fiber cable includes the optical fiber, a buffer coating surrounding the optical fiber, a cable jacket surrounding the buffer coating, and strength members axially disposed between the cable jacket and buffer coating, wherein the jacketed optical fiber cable is configured to include a jacket band comprising a portion of the cable jacket that is at least partially disposed within the cable jacket clamping portion.

10. The optical fiber connector of claim 9, wherein the jacket band is coupled to a slit portion of the cable jacket that expands outward upon axial displacement of the cable jacket away from the end of the optical fiber.

11. The optical fiber connector of claim 9, wherein the jacket band is detached from the remainder of the cable jacket.

12. A method for terminating a jacketed optical fiber cable into an optical connector having a fiber stub and a cable jacket clamp, wherein the jacketed optical fiber cable includes an optical fiber, a buffer coating surrounding the optical fiber, a cable jacket surrounding the buffer coating, and strength members axially disposed between the cable jacket and buffer coating, the method comprising:
removing a portion of the cable jacket at the terminal end of the jacketed optical fiber cable;
slitting a portion of the cable jacket along its axial length to form a slit portion of the cable jacket that is axially disposed between an intact portion of the cable jacket nearest the terminal end of the fiber cable, the intact portion called a jacket band, and the remainder of the cable jacket;
pulling the jacket band along the axial length of the optical fiber cable away from the terminal end of the fiber and towards the remainder of the cable jacket such that the slit portion expands outward from the optical fiber cable exposing the buffer coating and strength members;
preparing the terminal end of the optical fiber;
coupling the prepared terminal end of the fiber to the stub fiber and forming a splice between the terminal end of the fiber and the stub fiber;
sliding the jacket band toward the splice such that the slit portion is substantially returned to its pre-expanded shape, wherein at least a portion of the jacket band is disposed within the cable jacket clamp;
placing a protective tube over the jacket band and slit portion; and
securing a boot over the cable jacket clamp to clamp the cable jacket clamp onto the protective tube and to secure strength members to the optical connector.

13. The method of claim 12, wherein the splice is formed with a mechanical splice device and wherein the coupling includes contacting to the fiber stub with the prepared end of the fiber such as to form a bow in the optical fiber.

14. The method of claim 13, further comprising releasing the fiber bow after actuation of the mechanical splice.

15. A method for terminating a jacketed optical fiber cable into an optical connector having a fiber stub and a cable jacket clamp, wherein the jacketed optical fiber cable includes an optical fiber, a buffer coating surrounding the optical fiber, a cable jacket surrounding the buffer coating, and strength members axially disposed between the cable jacket and buffer coating, the method comprising:
removing a portion of the cable jacket at the terminal end of the jacketed optical fiber cable;
removing another portion of the cable jacket along its axial length between an intact portion of the cable jacket nearest the terminal end of the fiber cable, the intact portion called a jacket band, and the remainder of the cable jacket leaving an exposed portion of the optical fiber cable;
pulling the jacket band along the axial length of the optical fiber cable away from the terminal end of the fiber and towards the remainder of the cable jacket;
preparing the terminal end of the optical fiber;
coupling the prepared terminal end of the fiber to the stub fiber and forming a splice between the terminal end of the fiber and the stub fiber;
sliding the jacket band toward the splice, wherein at least a portion of the jacket band is disposed within the cable jacket clamp;
placing a protective tube over the jacket band and exposed portion of the optical fiber cable; and
securing a boot over the cable jacket clamp to clamp the cable jacket clamp onto the protective tube and to secure strength members to the optical connector.
